(19) United States
(12) Patent Application Publication
(10) Pub. No.: US 2024/0118962 A1
(43) Pub. Date: Apr. 11, 2024

(54) SHARING SYSTEM, SHARING METHOD, MAINTENANCE NODE, GENERATION NODE AND PROGRAM

(71) Applicant: Nippon Telegraph and Telephone Corporation, Tokyo (JP)

(72) Inventors: Haruka OSANAI, Musashino-shi, Tokyo (JP); Sho KANEMARU, Musashino-shi, Tokyo (JP); Kensuke TAKAHASHI, Musashino-shi, Tokyo (JP); Tsuyoshi TOYOSHIMA, Musashino-shi, Tokyo (JP)

(21) Appl. No.: 18/276,930

(22) PCT Filed: Feb. 16, 2021
(86) PCT No.: PCT/JP2021/005639

§ 371 Date: Aug. 11, 2023

(51) Int. Cl. G06F 11/07

(52) U.S. Cl. CPC G06F 11/0772; G06F 11/0709

(57) ABSTRACT

A sharing system includes an operation channel of a block chain that shares operation data including information on a construction failure of a resource used in a service provided to a customer among a plurality of nodes, a provision channel of the block chain for sharing provision data used for providing information on a predetermined construction failure for the resource to the customer among a plurality of nodes, a monitoring unit that participates in the operation channel and the provision channel and monitors for construction failures of the resource, a maintenance node including an update unit configured to update a detection state of construction failures in the provision data when detecting update of the state of the construction failure related to the provision channel to be participated, and a provision node that participates in the provision channel and includes a notification unit.

### TECHNICAL FIELD

The present invention relates to a sharing system, a sharing method, a maintenance node, a generation node, and program.

### BACKGROUND ART

Distributed ledger techniques such as block chains are known (NPL 1). The block chain is a technology in which multiple computers that make up a distributed network each have a ledger that records transaction histories, ensuring tamper resistance and transparency of transactions.

There is a system for reducing the cost when adding a new service or the like When services are provided cooperatively to customers (PTL 1). The configuration information of the cooperative service providing system constructed as a system construction is input to the configuration information management client. The configuration information management client confirms the registration completion of the configuration information, and then notifies the maintenance system of the result.

There is open source integrated monitoring software for centrally monitoring servers, networks, and applications (NPL 2).

### CITATION LIST

### Patent Literature

[PTL 1] Japanese Patent Application Laid-open No. 2018-206050

### Non Patent Literature

[NPL 1] Osonoi, “Blockchain/Hyperledger Fabric Introduction,” [online], Nov. 10, 2020, [retrieved on Feb. 8, 2021], the Internet URL:https://speakerdeck.com/osonoi/hyperledger-fabric-ru-men-bian-750c5a73-67d6-4ee3-9378-81d624c5e48e?slide=13
[NPL 2] Assist, “Zabbix Open Source Integrated Monitoring Tool,” [online], Nov. 10, 2020, [retrieved on Feb. 8, 2021], the Internet <URL:https://www.ashisuto.co.jp/product/category/system-management/zabbix/>

### SUMMARY OF INVENTION

### Technical Problem

The resources used for the services provided to a customer are appropriately constructed, and the occurrence of failures is monitored. Information on construction or failure for these resources is appropriately shared by persons concerned on the service providing side. Information on construction or failure should be provided appropriately to customers who use services. Since the customers affected by each construction or failure are different, there are cases where it is burdensome to provide information on the construction or failure.

The present invention has been made in view of the above circumstances, and an object of the present invention is to provide a technique capable of easily providing information on construction work or malfunctions to customers who use services.

### Solution to Problem

A sharing system according to one aspect of the present invention includes an operation channel of a block chain that shares operation data including information on a construction failure of a resource used in a service provided to a customer among a plurality of nodes, a provision channel of the block chain for sharing provision data used for providing information on a predetermined construction failure for the resource to the customer among a plurality of nodes, a monitoring unit that participates in the operation channel and the provision channel and monitors for construction failures of the resource, a maintenance node including an update unit configured to update a detection state of construction failures in the provision data when detecting update of the state of the construction failure related to the participating provision channel, and a provision node that participates in the provision channel and includes a notification unit that notifies the customer of the updated state of the construction failure by referring to the provision data.

A sharing method according to one aspect of the present invention includes causing a maintenance node participating in an operation channel of a block chain that shares operation data including information on a construction failure of a resource used in a service provided to a customer among a plurality of nodes and a provision channel of the block chain for sharing provision data used for providing information on a predetermined construction failure for the resource to the customer among a plurality of nodes to monitor a construction failure of a resource, causing the maintenance node to update a detection state of construction failures in the provision data when detecting update of the state of the construction failure related to the participating provision channel, and causing a provision node participating in the provision channel to refer to the provision data and notify the customer of the updated state of the construction failure.

A maintenance node according to an aspect of the present invention includes a monitoring unit participating in an operation channel of a block chain that shares operation data including information on a construction failure of a resource used in a service provided to a customer among a plurality of nodes, and a provision channel of the block chain for sharing provision data used for providing information on a predetermined construction failure for the resource to the customer among a plurality of nodes, and that monitors for construction failures of the resource, and an update unit configured to update a detection state of construction failures in the provision data when detecting update of the state of the construction failure related to the participating provision channel.

A generation node according to one aspect of the present invention includes a generation unit that generates a block chain provision channel sharing provision data related to other construction failure information when the other construction failure information is registered in operation data including construction failure information of a resource used in a service provided to a customer, and a request unit that requests a maintenance node participating in an operation channel of a block chain sharing the operation data with another node to participate in the provision channel, and requests registration of information on the other construction failure in the operation data in the provision data.

One aspect of the present invention is a program that causes a computer to function as the maintenance node or generation node.

### Advantageous Effects of Invention

According to the present invention, it is possible to provide a technique capable of easily providing information on construction or failure even to a customer who uses a service.

### BRIEF DESCRIPTION OF DRAWINGS

FIG. 1 is a diagram illustrating a system configuration of a sharing system according to an embodiment of the present invention.

FIG. 2 is a diagram illustrating an outline of processing of the sharing system.

FIG. 3 is a diagram illustrating an example of a data structure of operation data.

FIG. 4 is a diagram illustrating a sequence of the sharing system (1).

FIG. 5 is a diagram illustrating a sequence of the sharing system (2).

FIG. 6 is a diagram illustrating an example of operation data registered in a sequence illustrated in FIGS. 4 and 5 (1).

FIG. 7 is a diagram illustrating an example of operation data registered in the sequence illustrated in FIGS. 4 and 5 (2).

FIG. 8 is a diagram illustrating an example of operation data registered in the sequence illustrated in FIGS. 4 and 5 (3).

FIG. 9 is a diagram illustrating functional blocks of a maintenance node.

FIG. 10 is a flowchart illustrating processing of the maintenance node.

FIG. 11 is a diagram illustrating functional blocks of a generation node.

FIG. 12 is a diagram illustrating a hardware configuration of a computer used for each node.

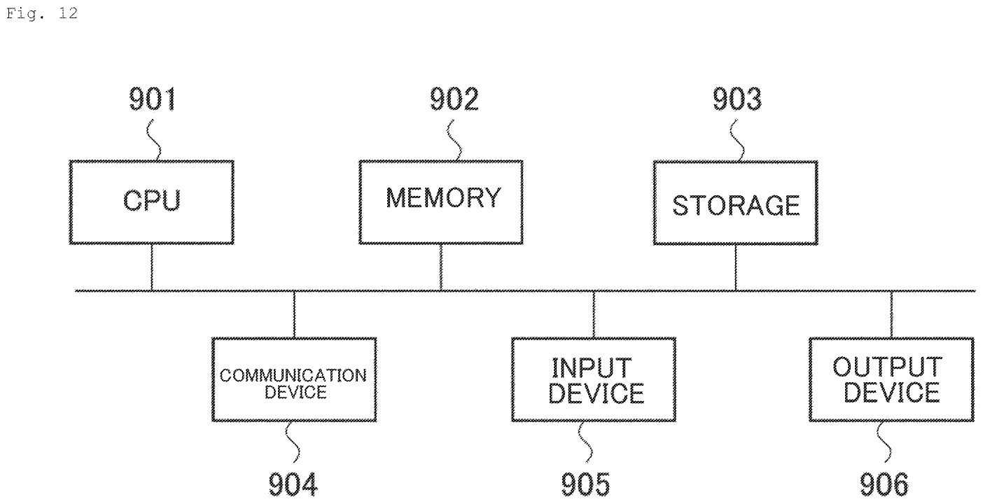

### DESCRIPTION OF EMBODIMENTS

Hereinbelow, a description will be given of an embodiment of the present invention with reference to the drawings. Same parts in the drawings will be designated by the same reference characters and descriptions thereof will be omitted accordingly.

### (Sharing System)

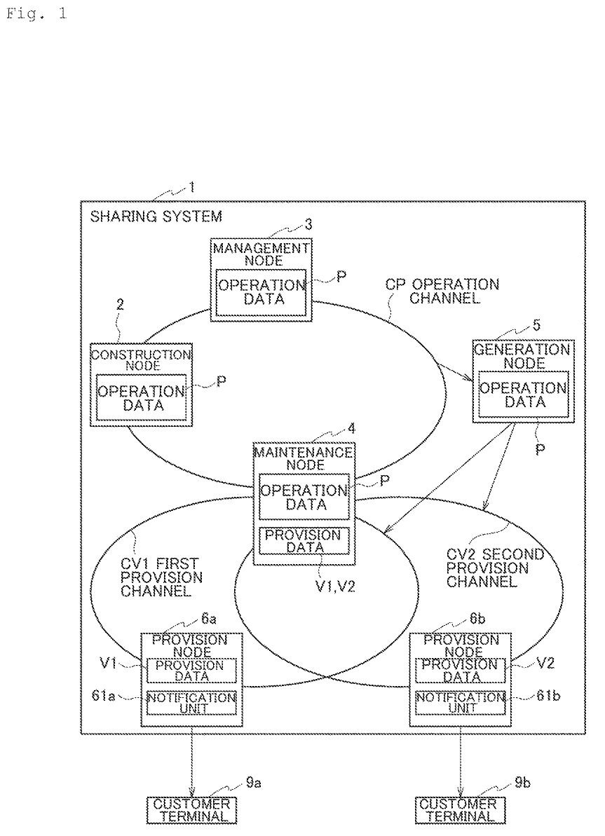

A sharing system 1 illustrated in FIG. 1 shares information on a construction or failure of resources used in a service provided to a customer by a manager of the resources and provides the customer with the information. Construction or failure” may be referred to as “construction failure”.

In the sharing system 1, a range for sharing information on resources is set using a Hyperledger Fabric function of a block chain. In the example illustrated in FIG. 1, the sharing system 1 includes an operation channel CP, a first provision channel CV1 and a second provision channel CV2, a construction node 2, a management node 3, a maintenance node 4, a generation node 5, a first provision node 6a and a second provision node 6b.

The operation channel CP, the first provision channel CV1 and the second provision channel CV2 are channels in which a range for sharing data is set using a Hyperledger Fabric function of a block chain, respectively. Data of the channel is shared between nodes participating in the channel.

The operation channel CP is used to provide services to the customer. The operation channel CP shares operation data P including information on a construction failure of a resource used in a service provided to a customer among a plurality of nodes. In the operation channel CP, the operation data P is shared between nodes on the service providing side. In the example shown in FIG. 1, construction node 2, management node 3 and maintenance node 4 participate in operation channel CP and share operation data P.

The operation data P includes, for example, customer resource data and construction failure data. The customer resource data associates the identifier of the customer with the identifier of the resource used in the service to be provided to the customer. The construction failure data associates the identifier of the resource with the state of construction or failure with the identifier of construction or failure for the resource. Since the operation data P is formed by a block chain mechanism, falsification resistance or transparency of the transaction is secured.

The construction node 2 registers customer information and contract information in the operation data P with respect to a service contract with the customer. The management node 3 registers the information of the service and the information of the resources allocated by the service in the operation data P when providing the service to the customer. The maintenance node4 registers information on a construction schedule for a resource used for providing a service to a customer or information on occurrence of a failure detected at the time of monitoring the resource in the operation data P.

The first provision channel CV1 and the second provision channel CV2 are used to provide information on construction failure to a customer. The first provision channel CV1 and the second provision channel CV2 share provision data V used for providing information on predetermined construction failure for the resources to the customer among the plurality of nodes. The first provision channel CV1 and the second provision channel CV2 share information on different construction failures. Since the first provision channel CV1 and the second provision channel CV2 are respectively formed by a block chain mechanism, falsification resistance or transparency of a transaction is secured.

In the first provision channel CV1, first provision data V1 is shared between the maintenance node 4 and the first provision node 6a. The maintenance node4 also participates in the operation channel CP, registers information on the construction failure in the operation data P, and registers information on the construction failure related to the first provision channel CV1 in the first provision data V1. The first provision node 6a notifies a customer terminal 9a related to the construction failure of information on the construction failure shared by the first provision channel CV1.

Second provision data V2 is shared between the maintenance node 4 and the second provision node 6b in the second provision channel CV2. The maintenance node 4 also participates in the operation channel CP, registers the information of the construction failure in the operation data P, and registers the information of the construction failure related to the second provision channel CV2 in the second provision data V2. The second provision node 6b notifies a customer terminal 9b related to the construction failure of information on the construction failure shared by the second provision channel CV2.

The first provision data V1 and the second provision data V2 respectively associate a state of the construction failure with an identifier of a customer related to a resource to be a target of the construction failure, with an identifier of a predetermined construction failure. The first provision data V1 and the second provision data V2 have information on identifiers of different construction failures. Since the first provision data V1 and the second provision data V2 are formed by a block chain mechanism, falsification resistance or transparency of a transaction is secured.

When a new construction failure is registered in the operation channel CP, the generation node 5 generates the provision channel CV for providing information on the construction failure to the customer. The provision channel CV is generated for each construction failure registered in the operation channel. The construction failure is one construction or one failure counted in the sharing system 1, and is specified by one identifier until the construction or failure is completed.

The provision data V shared in the provision channel CV associates a state of the construction failure with an identifier of a predetermined construction failure as information on the construction failure, and an identifier of a customer related to a resource or service to be a target of the construction failure.

In the example shown in FIG. 1, sharing system 1 will be described with one operation channel CP and two providing channels CV1 and CV2, but is not limited thereto. The sharing system 1 may be provided with one or more operation channels CP and the provision channel CV for each construction or failure generated for the resource.

In the example illustrated in FIG. 1, the case where the maintenance node 4 participates in both the first provision channel CV1 and the second provision channel CV2 will be described, but there is no limitation thereto. The sharing system includes a plurality of maintenance nodes 4, one maintenance node may participate in the first provision channel CV1 and the other maintenance node may participate in the second provision channel CV2.

If the first provision channel CV1 and the second provision channel CV2 are not particularly distinguished, it may be simply referred to the provision channel CV. If the first providing channel CV1 and the second providing channel CV2 are not particularly distinguished, it may be simply described as the providing channel CV. When the first provision node 6a and the second provision node 6b are not particularly distinguished, it may be simply referred to the provision node 6. When the first provision data V1 and the second provision data V2 are not particularly distinguished, they may be simply referred to as provided data V.

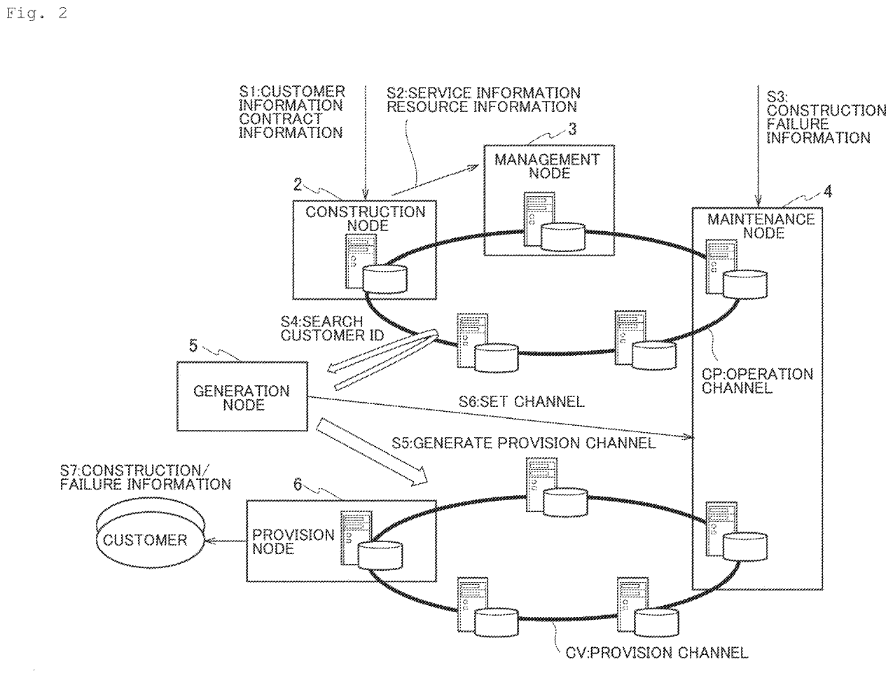

An outline of processing in the sharing system 1 will be described with reference to FIG. 2. FIG. 2 illustrates (1) registration processing of new customer information and contract information to the operation channel CP, (2) registration processing of construction failure information to resources to the operation channel CP, (3) generation processing of the provision channel CV for providing the registered construction failure information to the customer, and (4) notification processing of the construction failure information shared by the provision channel CV to the customer.

When the customer newly makes a contract with the service, the construction node 2 issues a transaction for registering the customer information and the contract information in the operation channel CP in step S1. The customer information and the contract information are registered in the operation data P. The operation data P in which the customer information and the contract information are registered are slowly synchronized between nodes participating in the operation channel CP.

In step S2, the management node 3 updates service information to be provided to the customer according to the contract information registered in step S1, and allocates resources for providing the service to the customer. The management node 3 issues a transaction for registering the service information and the resource information in the operation channel CP. The service information and the resource information are registered in the operation data P. The operation data P in which the service information and the resource information are registered are slowly synchronized between nodes participating in the operation channel CP.

In step S3, the maintenance node 4 monitors resources allocated by the service provided to the customer. When detecting a construction failure to the resource, the maintenance node 4 issues a transaction to be registered in the operation channel CP according to the detected construction failure information. The construction failure information is registered in the operation data P. The operation data P in which the construction failure information is registered is slowly synchronized between nodes participating in the operation channel CP.

When the generation node 5 detects that new construction failure information is registered in the operation data P, the generation node 5 retrieves an identifier of a customer related to the construction failure in step S4. In step S5, the generation node 5 generates the provision channel CV for providing the information of the construction failure to the customer retrieved in step S4.

In step S6, the generation node 5 requests the maintenance node 4 and the provision node 6 to participate in the provision channel CV generated in step S5. In step S6, the generation node 5 requests the maintenance node 4 to register information on the construction failure which is a trigger to retrieve the identifier of the customer in step S4 in the provision channel CV. The maintenance node 4 acquires information on a construction failure related to the provision channel CV and information on a customer to which a resource to be a target of the construction failure is allocated from the operation channel CP. The maintenance node 4 issues a transaction for registering the acquired information on the construction failure and the information on the customer in the provision channel CV. When the construction fault information related to the provision channel CV is updated in the operation channel CP, the maintenance node 4 issues a transaction for registering the updated information in the provision channel CV. The updated information of the construction failure is registered in the provision channel CV. The provision data V in which the information on the construction failure is registered is slowly synchronized between nodes participating in the provision channel CV.

The providing node6 monitors the providing data V of the providing channel CV, and when the data of the providing data V are updated, the providing node 6 provides the updated data to the customer in step S7.

The provision node 6 refers to the provision data V and notifies the customer of the state of the updated construction failure. The provision node 6 refers to the provision data V and specifies a contact address such as a mail address of the customer. The provision node 6 notifies the specified contact address of the state of the construction failure updated by the provision data V. The provision node 6 may selectively provide the data, such as providing the updated data to the customer in a case where the updated data satisfies a predetermined condition, and not providing the updated data to the customer otherwise.

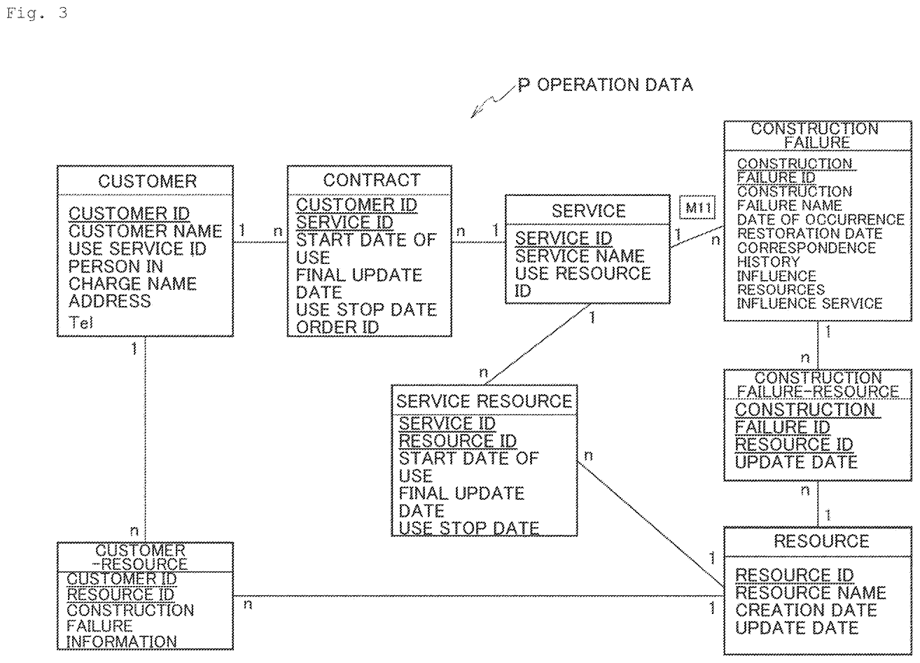

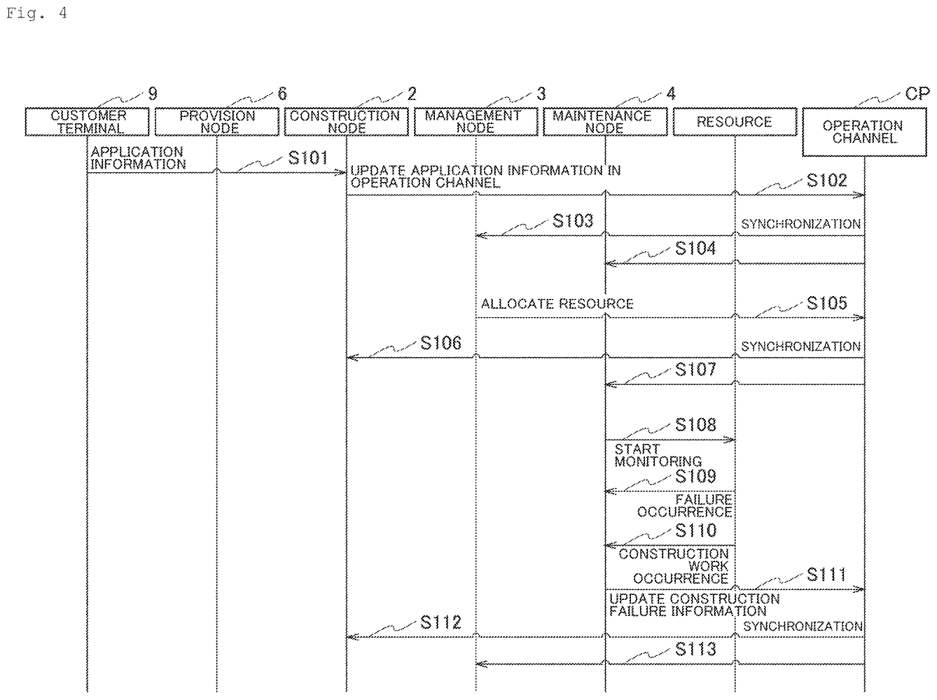

Referring to FIG. 3, an example of the operation data P shared by the operation channel CP will be described. The operation data P includes customer information, contract information, service information, service resource information, resource information, construction failure information, construction failure-resource information, customer-resource information, and the like. The data structure illustrated in FIGS. 3 and 4 is one example, and there is no limitation to this example.

The customer information is associated with information such as a customer name, an identifier of service to be used, and a contact address by using an identifier (ID) of the customer as a key. The contract information associates information such as a use start date with the identifier of the customer and the identifier of the service as a key.

The service information associates the service name and the identifier of the use resource with each other by using the identifier of the service as a key. Service-resource information associates information such as a use start date with the identifier of the service and the identifier of the resource as keys. The service-resource information associates information such as a use start date with the identifier of the service and the identifier of the resource as keys. The resource information associates a resource name or the like with the identifier of the resource as a key.

The construction failure information associates the construction failure name, the occurrence date, the restoration date, the correspondence history, the information on the resources affected by the construction failure, and the information of the service, using the identifier of the construction failure as a key. The construction failure-resource information associates an update date or the like with the identifier of the construction failure and the identifier of the resource as a key. The customer-resource information is associated with the construction failure information with the identifier of the customer and the identifier of the resource as a key.

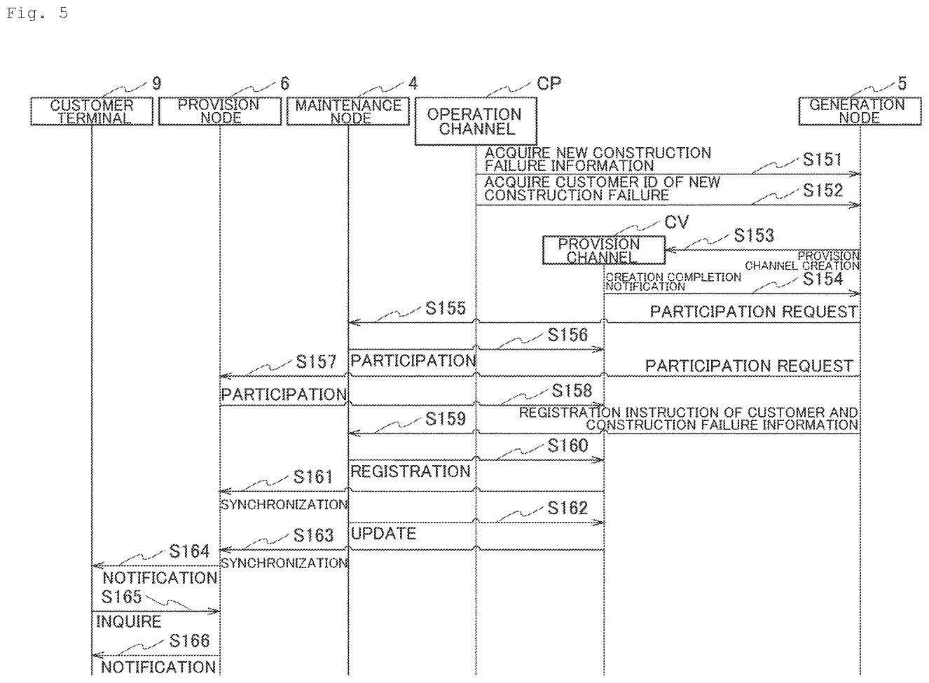

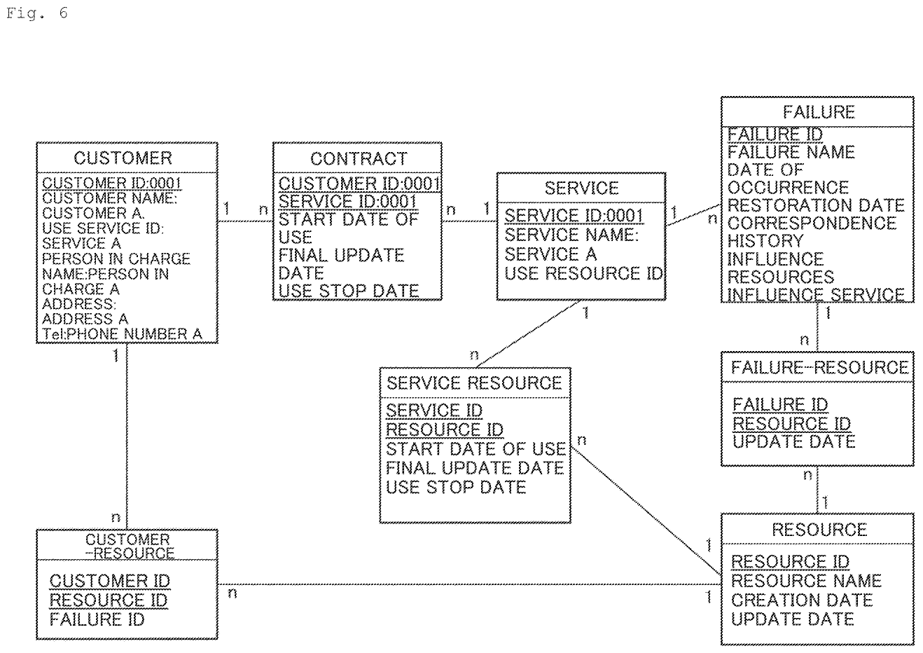

Processing in the sharing system 1 will be described with reference to FIGS. 4 and 5. Although an example of data registered in the operation data P will be described with reference to FIGS. 6 to 8, the present invention is not limited thereto. For example, when a customer applies an existing service or when an existing resource is allocated, the service information, resource information, or the like may be registered in the information of the service applied by the customer or the information of the resource allocated to the customer in advance. Further, in FIGS. 6 to 8, the construction work and the failure are described by paying attention to the failure such as the description of the construction failure information as the failure information.

First, in step S101, the construction node 2 acquires application information from the customer terminal 9. In step S102, the construction node 2 updates the application information acquired in step S101 to the operation data P of the operation channel CP. According to the update of the operation channel CP in step S102, each operation data P of the management node 3 and the maintenance node 4 are also synchronized in steps S103 and S104.

At this time, the data shown in FIG. 6 is registered in the operation data P. In the example illustrated in FIG. 6, the identifier of the customer, the name of the customer, the contact address, and the like are registered in the customer information. The identifier of the customer, the identifier of the service applied by the customer, and the like are registered in the contract information. In the service table information, the identifier of the service applied by the customer, the name of the service and the like are registered.

In step S105, the management node 3 allocates resources according to the application information synchronized in step S103, and updates the operation channel CP. According to the update of the operation channel CP in step S105, each operation data P of the construction node 2 and the maintenance node 4 are also synchronized in steps S106 and S107.

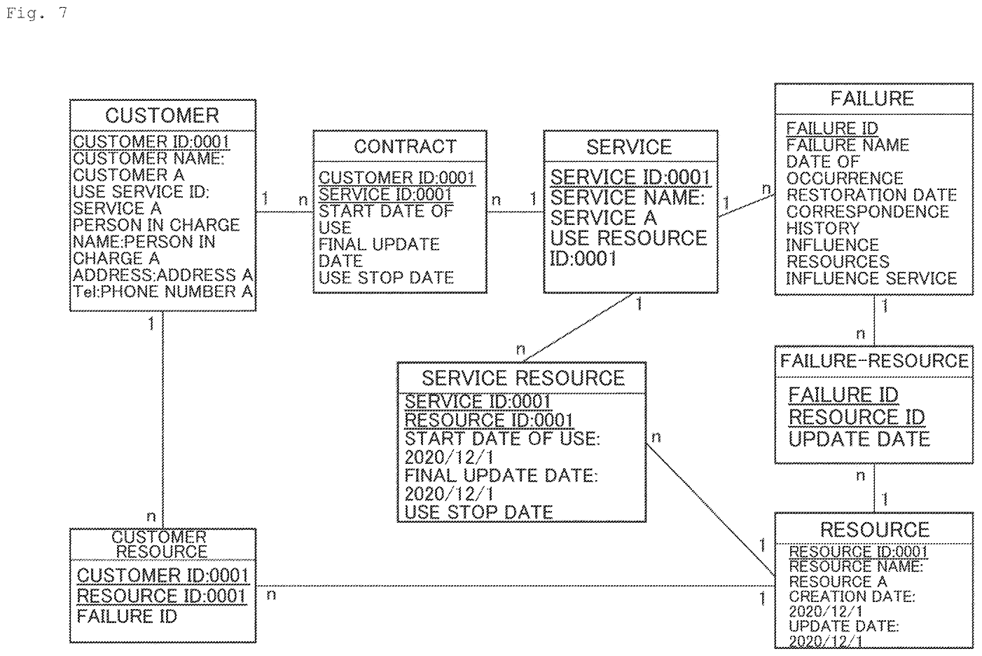

At this time, the data illustrated in FIG. 7 is registered in the operation data P. In the example illustrated in FIG. 7, the identifier of the resource allocated to the service applied by the customer or the like is registered in the service-resource information in comparison with the example illustrated in FIG. 6. The identifier of the customer and the identifier of the resource allocated to the customer are registered in the customer-resource information. In addition, an identifier of a resource, a resource name, and the like are registered in the resource information.

In step S108, the maintenance node 4 starts monitoring resources used in the service. As illustrated in step S109, the maintenance node 4 detects a failure of the resource from an alarm or the like issued by the resource. As illustrated in step S110, the maintenance node 4 may detect the occurrence of construction for the resource.

When the maintenance node 4 detects construction or failure, the maintenance node 4 updates the operation channel CP in step S111. According to the update of the operation channel CP in step S111, in steps S112 and S113, the respective operation data P of the construction node 2 and the management node 3 are also synchronized.

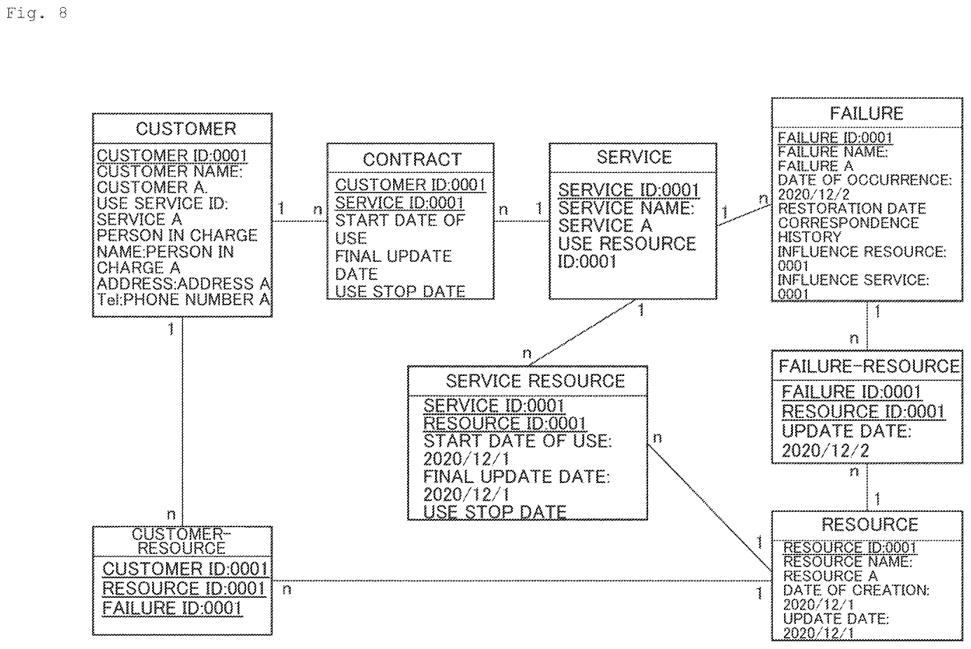

At this time, the data illustrated in FIG. 8 is registered in the operation data P. In the example illustrated in FIG. 8, the identifier of the resource allocated to the service applied by the customer and the like are registered in the failure information in comparison with the example illustrated in FIG. 7. In the example shown in FIG. 8, the identifier of the resource allocated to the service applied by the customer and the like are registered in the failure information in comparison with the example shown in FIG. 7. An identifier of the customer, an identifier of a resource allocated to the customer, an identifier of a failure related to the resource, and the like are registered in the customer-resource information. In addition, an identifier of a resource, a resource name, and the like are registered in the resource information.

In step S151, the generation node 5 acquires new construction failure information by referring to the operation channel CP. In step S152, the generation node 5 refers to the operation channel CP and acquires the identifier of the customer related to the new construction failure acquired in step S151. In step S151, a new construction failure is specified as a failure of an identifier “0001”. For the identifier “0001” of the failure specified in step S151, the identifier “0001” of the customer to which an influence service “0001” and the identifier “0001” of the influence resource are assigned in the failure information is specified in step S152.

In step S153, the generation node 5 generates the provision channel CV. The generated provision channel is used to provide the customer specified in step S152 with the information on the failure specified in step S151.

In step S154, the generation node 5 receives the generation completion notification of the provision channel CV. In step S155, the generation node 5 transmits a request for participation in the provision channel CV to the maintenance node 4. In step S156, the maintenance node 4 participates in the provision channel CV. In step S157, the generation node 5 transmits a request for participation in the provision channel CV to the provision node 6. In step S158, the provision node 6 participates in the provision channel CV.

In step S159, the generation node 5 instructs the maintenance node 4 to register the customer information and the construction failure information in the provision channel CV. The information registered here is the construction failure acquired in step S151 and the information on the customer acquired in step S152. The information registered in the provision channel CV by the maintenance node 4 is information necessary for notifying a situation of a construction failure such as a notification destination, or information which may be provided to a customer such as a construction failure situation. In step S160, the maintenance node 4 registers the customer information and the construction failure information in the provision channel CV. According to the update of the provision channel CV in step S160, each operation data P of the construction node 2 and the maintenance node 4 are also synchronized in step S161.

When the maintenance node 4 detects update of the customer information and the construction failure information in step S162, the maintenance node 4 registers the updated information in a provision channel CV. According to the update of the provision channel CV in step S162, the provision data V of the provision node 6 is also synchronized in step S163.

In step S164, the providing node 6 notifies the customer terminal 9 of the state of the construction failure according to providing data V synchronized with other nodes belonging to the providing channel CV. The timing at which the providing node 6 notifies the customer terminal 9 may be set to the providing data V and the operation data P, or may be designated by the generating node 5. Although not illustrated in FIG. 5, the provision node 6 may notify the customer terminal 9 of the situation of the construction failure after synchronizing the provision channel CV in step S161. When receiving an inquiry from the customer terminal 9, the provision node 6 may notify the customer terminal 9 of the situation of the construction failure.

In step S165, the provision node 6 receives an inquiry about the situation of the construction failure from the customer terminal 9. In step S166, the provision node 6 transmits the situation of the construction failure registered in the provision channel CV to the customer terminal 9.

### (Maintenance Node)

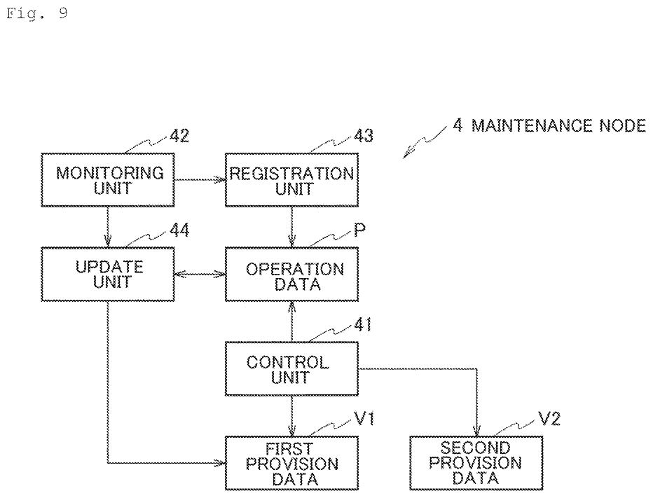

The maintenance node 4 will be described with reference to FIG. 9. The maintenance node 4 participates in the operation channel CP and the provision channel CV.

The maintenance node 4 includes the operation data P, the data of the first provision data V1 and the second provision data V2, and each functional unit of a control unit 41, a monitoring unit 42, a registration unit 43, and an update unit 44. Each data is stored in a memory 902 or a storage 903.

Each function is mounted on a CPU 901.

Each data of the operation data P, the first provision data V1, and the second provision data V2 is shared with other nodes in the operation channel CP, the first provision channel CV1, and the second provision channel CV2.

The control unit 41 synchronizes the operation data P, the first provision data V1, and the second provision data V2 with other nodes. When the control unit 41 receives transactions regarding these data, the control unit 41 processes the transactions and synchronizes these data.

The monitoring unit 42 monitors a construction failure of the resource. The monitoring unit 42 monitors resources used for services provided to the customer, and detects construction or failure occurring in the resources.

When the monitoring unit 42 detects a new construction failure, a registration unit 43 registers information on the construction failure in the operation data P. The registration unit 43 assigns an identifier for new construction or failure and issues a transaction for updating construction failure information of operation data P of each node participating in the operation channel CP. The registration unit 43 updates the operation data P held in the maintenance node.

The update unit 44 updates the detection state of construction failures in the operation data P and the provision data V when detecting the update of the state of the construction failure related to the provision channel CV in which the maintenance node 4 participates. The maintenance node 4 searches for the presence or absence of update of the state of the construction failure for resources related to each provision channel CV to which the node itself participates.

The maintenance node 4 belongs to both the first provision channel CV1 and the second provision channel CV2. The update unit 44 issues a transaction for updating first provision data V1 of each node participating in the first provision channel CV1 when detecting update of a state of a construction failure related to the first provision channel CV1 among the first provision channel CV1 and the second provision channel CV2. The update unit 44 updates the operation data held in the maintenance node 4.

The update unit 44 issues a transaction for updating the operation data P when detecting the update of the state of the construction failure not related to the provision channel CV to which the maintenance node 4 participates. The update unit 44 updates the operation data P held in the maintenance node 4.

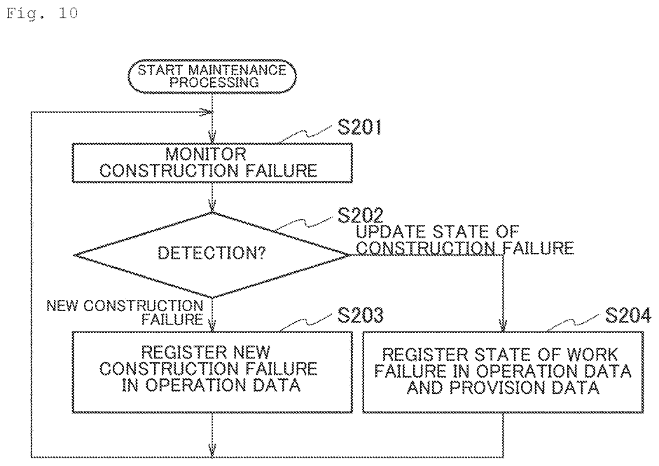

Processing by maintenance node 4 will be described with reference to FIG. 10.

In step S201, the maintenance node 4 monitors construction or failure in the resource.

When a new construction or failure is detected in step S202, the processing proceeds to step S203. In step S203, a new construction failure is registered in the operation data P.

When the update of the state of construction or failure is detected in step S202, the processing proceeds to step S204.

In step S204, the state of the construction or failure after the update is registered in the operation data P and the provision data V.

The maintenance node 4 participates in both the operation channel CP and the provision channel CV. The maintenance node4 registers the information registered in the operation channel in a necessary providing channel CV. Only information necessary for notification to the customer is registered in the provision channel CV. The provision node 6 participating in the provision channel CV can appropriately notify the customer of information necessary for notification.

### (Provision Node)

The provision node 6 participates in the provision channel CV.

As illustrated in FIG. 1, the provision node 6 includes provision data V and a notification unit 61.

The notification unit 61 refers to the provision data V and notifies the customer of the state of the updated construction failure. The providing node6 refers to the providing data V and specifies a contact address such as a mail address of the customer. The notification unit 61 notifies the specified contact address of the state of the construction failure updated by the provision data V. The notification unit 61 may selectively provide the data, such as providing the updated data to the customer in a case where the updated data satisfies a predetermined condition, and not providing the updated data to the customer otherwise.

When receiving an inquiry about the state of the construction failure from the customer, the notification unit 61 refers to the provision data V to notify the state of the construction failure related to the customer. The notification unit 61 specifies provision data V having construction failure information related to the customer of the inquiry source, and returns the state of construction failures in the customer by referring to the specified provision data.

Although not illustrated in FIG. 1, the provision node 6 includes a control unit for synchronizing the provision data V with other nodes. When the control unit receives a transaction regarding the data, the control unit processes the transaction and synchronizes the data.

### (Generation Node)

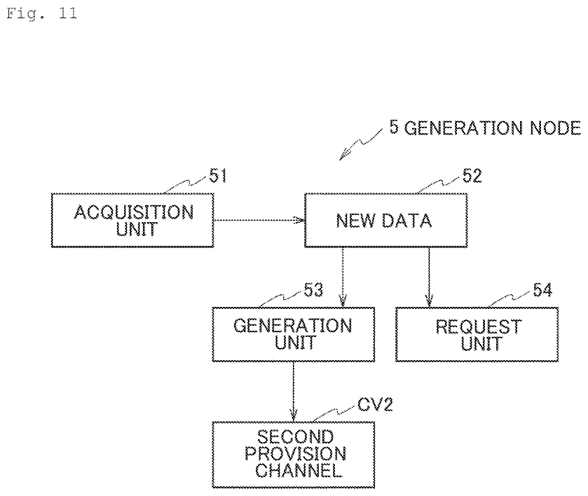

A generation node 5 will be described with reference to FIG. 11.

The generation node 5 includes data of new data 52, and respective functions units of an acquisition unit 51, a generation unit 53, and a request unit 54. The data is stored in a memory 902 or a storage 903. Each function is mounted on a CPU 901.

An acquisition part51 acquires construction failure information newly registered in the operation data P and information on a customer related to the construction failure, and generates new data 52. The new data 52 includes newly registered construction failure information and customer information related to the construction failure.

There are several methods for the acquisition unit 51 to generate new data 52. The acquisition unit 51 may acquire the operation data P from any reliable node participating in the operation channel CP, and generate the new data 52 from the acquired operation data P. The acquisition unit 51 may request any of the reliable participating nodes in the operation channel CP to acquire newly registered construction failure information and customer information related to the construction failure, and acquire the new data 52 generated by the request. In addition, when the generation node 5 participates in the operation channel CP, the new data 52 may be generated from the operation data P possessed by the generation node 5 itself.

When information on the new construction failure is registered in the operation data P, the generation unit 53 generates the provision channel CV of a block chain sharing the provision data V related to the new construction failure information. For example, when the new construction failure information is registered in the operation data P in a state where the first provision channel CV1 already exists in the sharing system 1, the generation unit 53 generates the second provision channel CV2 for notifying the customer of the new construction failure information. The second provision data V2 for notifying a customer of new construction failure information is shared by the second provision channel CV2.

A request unit54 requests the maintenance node 4 and the providing node 6 to participate in the providing channel generated by the generation unit 53. A request part54 requests the maintenance node 4 to register information on new construction failure in the operation data P to the provision channel generated by the generation part 53. When the generation unit 53 generates a second provision channel CV2, a request unit 54 requests the maintenance node 4 and the provision node to participate in the second provision channel CV2. The request unit 54 requests the maintenance node 4 to register information for notifying the customer of the information on the construction failure related to the second provision channel CV2 in the second provision data V2 of the second provision channel CV2.

The generation node 5 generates one provision channel CV for one construction failure. The generation node 5 registers information for notifying a customer related to the provision channel CV of construction failure information in the provision channel CV.

The sharing system 1 can easily provide information on construction or failure related to a service to a customer who uses the service among construction failure information shared by an operator who provides the service.

A general-purpose computer system including, for example, a central processing unit (CPU, processor) 901, a memory 902, a storage 903 (Hard Disk Drive (HDD), Solid State Drive (SSD)), a communication device 904, a communication device 904, an input device 905, and an output device 906 is used for each node of the present embodiment described above. In this computer system, the CPU 901 executes a predetermined program loaded into the memory 902, and the functions of the individual nodes are thereby realized.

Note that each node may be implemented by one computer, or may be implemented by a plurality of computers. Also, each node may be a virtual machine implemented in a computer.

The program of each node can be stored in a computer-readable recording medium such as an HDD, an SSD, a Universal Serial Bus (USB) memory, a compact disc (CD), or a digital versatile disc (DVD), or can be distributed via a network.

Note that the present invention is not limited to the above embodiment, and various modifications may be made without departing from the gist thereof.

### REFERENCE SIGNS LIST

1 Sharing system
2 Construction node
3 Management node
4 Maintenance node
5 Generation node
6 Provision node
9 Customer terminal
41 Control unit
42 Monitoring unit
43 Registration unit
44 Update unit
51 Acquisition unit
52 New data
53 Generation unit
54 Request unit
61 Notification unit
901 CPU
902 Memory
903 Storage
904 Communication device
905 Input device
906 Output device
CP Operation channel
CV Provision channel
P Operation data
V Provision data

1. A sharing system comprising:
an operation channel of a block chain configured to share operation data including information on a construction failure of a resource used in a service provided to a customer among a plurality of nodes;
a provision channel of the block chain configured to share provision data that provides information on a predetermined construction failure of the resource to the customer among a plurality of nodes;
a monitoring unit implemented using one or more processors, configured to (i) participate in the operation channel and the provision channel and (ii) monitor for construction failures of the resource;
a maintenance node including an update unit implemented using one or more processors, configured to update a detection state of construction failures in the provision data in response to detecting update of the state of the construction failure related to the participating provision channel; and
a provision node configured to participate in the provision channel, wherein the provision node includes a notification unit implemented using one or more processors, configured to notify the customer of the updated state of the construction failure by referring to the provision data.

2. The sharing system according to claim 1, further comprising:
a generation unit configured to generate another provision channel of the block chain configured to share another provision data related to a new construction failure information when the new construction failure information is registered in the operation data; and
a generation node that includes a request unit configured to (i) request the maintenance node and the provision node to participate in the other provision channel, and (ii) request the maintenance node to register the information of the new construction failure in the operation data to the other provision channel.

3. The sharing system according to claim 1, wherein the notification unit of the provision node is configured to refer to, when receiving an inquiry about a state of a construction failure from the customer, the provision data to notify the state of the construction failure related to the customer.

4. A sharing method comprising:
causing a maintenance node participating in an operation channel of a block chain that shares operation data including information on a construction failure of a resource used in a service provided to a customer among a plurality of nodes and a provision channel of the block chain for sharing provision data used for providing information on a predetermined construction failure for the resource to the customer among a plurality of nodes to monitor a construction failure of a resource;
causing the maintenance node to update a detection state of construction failures in the provision data when detecting update of the state of the construction failure related to the participating provision channel; and
causing a provision node participating in the provision channel to refer to the provision data and notify the customer of the updated state of the construction failure.

5. A maintenance node comprising:
a processor; and
a memory device storing instructions that, when executed by the processor, configure the processor to:
participate in an operation channel of a block chain that shares operation data including information on a construction failure of a resource used in a service provided to a customer among a plurality of nodes and a provision channel of the block chain for sharing provision data used for providing information on a predetermined construction failure for the resource to the customer among a plurality of nodes, and monitor for construction failures of the resource; and
update a detection state of construction failures in the provision data when detecting update of the state of the construction failure related to the participating provision channel.

6-7. (canceled)
